(19) United States
(12) Patent Application Publication
(10) Pub. No.: US 2004/0032958 A1
(43) Pub. Date: Feb. 19, 2004

(54) Wiring system for audiovisual devices and audiovisual system using the same

(75) Inventor: Pyoung-Yll Park, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon City (KR)

(21) Appl. No.: 10/356,488

(22) Filed: Feb. 3, 2003

(30) Foreign Application Priority Data
Aug. 19, 2002 (KR) 2002-48969

(51) Int. Cl. H04B 3/00; H04N 5/60

(52) U.S. Cl. 381/77; 381/79; 381/124

(57) ABSTRACT

A wiring system for AV devices uses a plurality of connector terminals installed on the walls of a room in which AV devices and speakers are placed, and an external cable is used for connecting the connector terminals. As the connections of the AV devices and speakers are made out of the room using the external cable, it is possible to keep the internal appearance of the room ordinarily neat no matter how many devices are connected to the system.

### CROSS-REFERENCE TO RELATED APPLICATIONS

This application claims the benefit of Korean Patent Application No. 2002-48969, filed on Aug. 19, 2002, in the Korean Intellectual Property Office, the disclosure of which is incorporated herein by reference.

### BACKGROUND OF THE INVENTION

1. Field of the Invention

The present invention relates to a wiring system for connecting audiovisual (AV) devices and an AV system having the same.

2. Description of the Related Art

Due to recent increasing demands for surround sound systems, such as, home theaters, it is preferable to have an integrated AV system by connecting a variety of separate AV devices such as video reproducing devices, television (TV) receivers, or audio component devices to a total sound system.

FIG. 1 shows a conventional arrangement in which various AV devices are connected to a total sound system. As shown in FIG. 1, a plurality of speakers 11a through 11g conveying audio to users are placed at several locations in a room 10 where a total sound system is constructed. Various AV devices including a TV 13, a digital video disk player (DVDP) 14, a video cassette recorder (VCR) 15, audio component devices 16 such as a compact disk (CD) or a long playing (LP) record player, a set top box 17, a projector 18, and the speakers 11a through 11g, are connected to an AV amplifier 12. Audio signals from any of the separate AV devices 13 through 18 are conveyed to the speakers 11a through 11g via the AV amplifier 12 so that the users can enjoy the audio streaming from the speakers 11a through 11g.

However, such a conventional arrangement as shown in FIG. 1 has a problem in that the neatness of the room 10 is significantly impaired by complicated cable connections, since the AV amplifier 12 and the various AV devices 13 through 18 are directly connected using cables 20 within the room 10. Furthermore, once the cable connections become complicated, it becomes difficult to find specific cables and to rearrange them or to move them from one place to another.

Accordingly, it is desirable to have a wiring system to simplify such complicated cable connections.

### SUMMARY OF THE INVENTION

To solve the above and/or other problems, it is an aspect of the present invention to provide a wiring system for efficiently connecting AV devices that can be conveniently used without spoiling the internal appearance of a room, and to provide an AV system having the same.

Additional aspects and/or advantages of the invention will be set forth in part in the description which follows and, in part, will be obvious from the description, or may be learned by practice of the invention.

A wiring system for AV devices according to the present invention, by which AV devices and speakers placed in a room are connected to enable signal transmission, comprises a plurality of connector terminals provided at one or more locations on any wall of the room, including a ceiling, a floor, or side walls, and an external cable connecting each of the connector terminals together from outside of the room.

In addition, an AV system according to the present invention comprises AV devices and speakers placed in a room, and a cabling system connecting the AV devices and the speakers to enable signal transmission, wherein the wiring system comprises a plurality of connector terminals provided at one or more locations on any wall of the room, including a ceiling, a floor, or side walls, and an external cable connecting each of the connector terminals from outside of the room.

### BRIEF DESCRIPTION OF THE DRAWINGS

These and/or other aspects and advantages of the present invention will become more readily appreciated from the following description of the embodiments, taken in conjunction with the accompanying drawings of which:

FIG. 1 is a schematic diagram of a conventional arrangement for wiring AV devices;

FIG. 2 shows an AV system incorporating a wiring system for AV devices according to an embodiment of the present invention;

FIG. 3 shows an embodiment of a sub-receiver used in the wiring system shown in FIG. 2;

FIG. 4 shows an embodiment of a speaker and video connector used in the wiring system shown in FIG. 2; and

FIG. 5 shows an embodiment of a speaker connector used in the wiring system shown in FIG. 2.

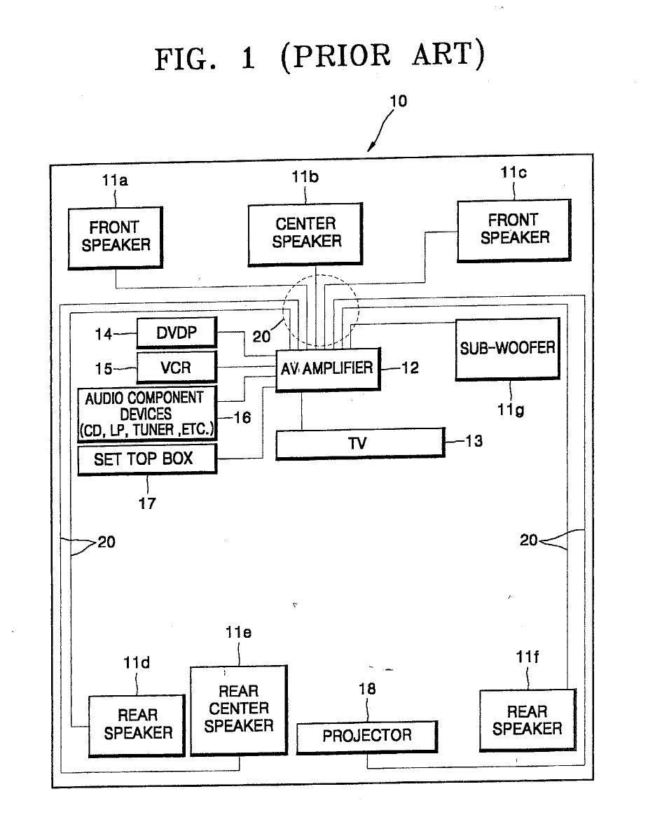

### DETAILED DESCRIPTION OF THE PREFERRED EMBODIMENTS

Embodiments of the present invention are described in more detail below and are illustrated in the attached drawings. Reference numerals are used to identify elements of the embodiments. The reference numerals in the specification correspond to the reference numerals in the drawings, with like reference numerals indicating like elements throughout.

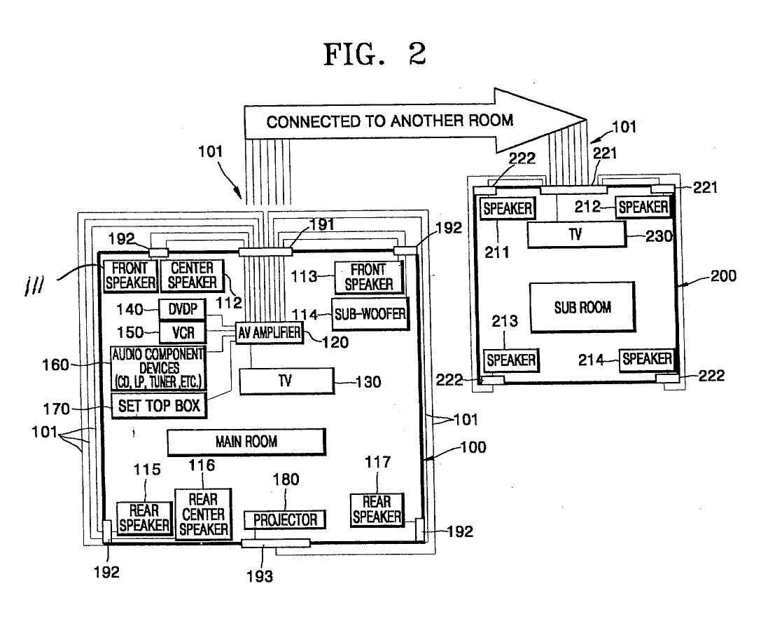

FIG. 2 shows an AV system incorporating a wiring system according to an embodiment of the present invention. As shown in FIG. 2, connector terminals are provided on an AV sub-receiver 191, speaker connectors 192, and a speaker and video connector 193 at one or more locations on a wall of a room 100 where speakers 111 through 117 and various AV devices including a TV 130, a DVDP 140, a VCR 150, audio component devices such as a CD or an LP player 160, a set top box 170 and a projector 180 are placed. The AV sub-receiver 191, speaker connector 192 and speaker and video connector 193 may be located on any wall of the room 100, including a ceiling, a floor, or side walls. Further, each of the AV devices 130 through 170 is connected to the AV sub-receiver 191 via an AV amplifier 120. More specifically, AV devices 130 through 170 are connected to the AV amplifier 120 and the AV amplifier 120 is connected to the AV sub-receiver 191. The speaker connectors 192 and the speaker and video connector 193 also connect the speakers 111 through 117 and the projector 180 to the AV sub-receiver, respectively.

The speaker and video connector 193 the speaker connectors 192, and the AV sub-receiver 191 transmit audio and video signals simultaneously, for example, to the projector 180, and to the speakers 111 through 117. The speaker connectors 192 and the speaker and video connector 193 are connected to the AV sub-receiver 191 using an external cable 101 that is provided outside the room for remote operation. For example, the external cable 101 may be installed in the walls, above the ceiling, or below the floor of the room 100. An external cable 101 also connects the AV sub-receiver 191 to another AV sub-receiver 221 placed in a different room 200, so that video or audio signals transmitted from the main room 100 can be received by and enjoyed with a TV 230 and speakers 211 through 214 placed in the sub room 200.

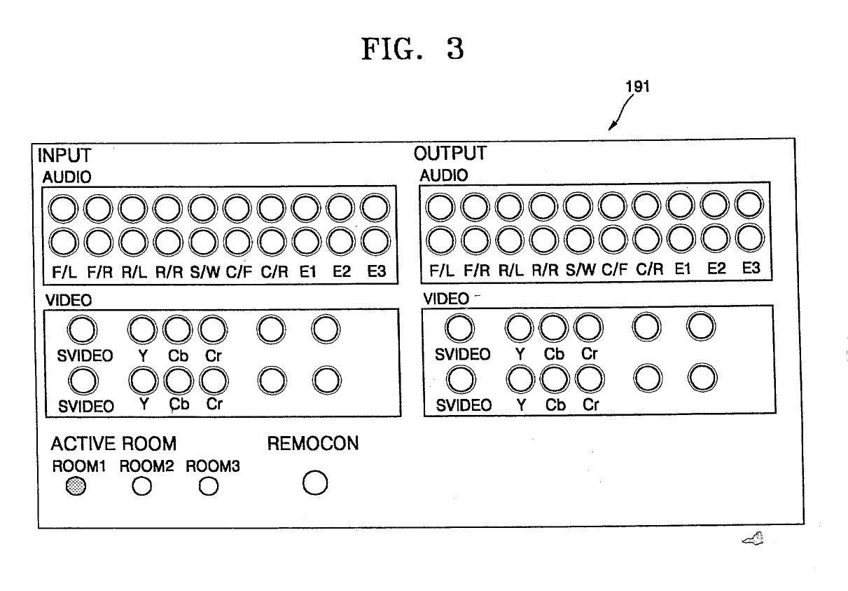

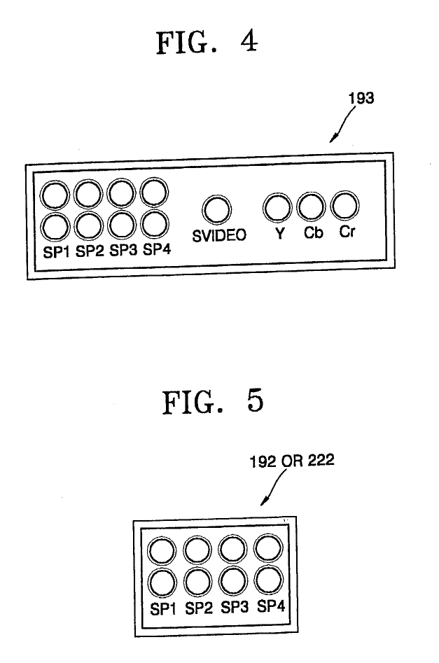

As shown in FIG. 3, each of the AV sub-receivers 191 and 221 has audio input/output terminals for audio signal transmissions, video input/output terminals for video signal transmissions, and display lamps for indicating the operational status of the audio visual system in each room. FIG. 4 shows an embodiment of the speaker and video connector 193, and FIG. 5 shows an embodiment of the speaker connectors 192 and 222.

With the arrangement as described above, audio signals provided from any of AV devices 130 through 180 are transmitted, via the AV amplifier 120, the video and speaker connector and the AV sub-receiver 191, and then through the external cable 101 and the speaker connectors 192, to the speakers 111 through 117 placed in the room 100. Accordingly, signals provided from any of the AV devices 130 through 180 placed in the room 100 can be enjoyed through the speakers 111 through 117 connected by way of the AV sub-receiver 191, speaker connector 192 and speaker and video connector 193 and the external cable 101.

Furthermore, it is possible to enjoy pictures with the TV 130 or the projector 180 by transmitting video signals from the DVDP 140 or the VCR 150 to the TV 130 via the AV amplifier 120, or to the projector 180 through the AV sub-receiver 191 and the speaker and video connector 193 that are connected by way of the external cable 101.

It is also possible to capture and enjoy video and/or audio signals in the sub room 200 by transmitting those signals from the main room 100 to the sub room 200 through the AV sub-receivers 191 and 221 that are connected by way of the external cable 101.

In an AV system incorporating the wiring system as described above, the internal appearance of the room 100 is ordinarily kept neat and well arranged no matter how many AV devices and speakers are connected, since the cable 101 wiring the AV devices 130 through 180 to the speakers 111 through 117, including the wiring between the AV sub-receiver 191, the speaker connectors 192 and the speaker and video connector 193 are not routed through the room, but are routed outside the room.

The AV system incorporating the wiring system as described above has merit in that it keeps the appearance of the room neat no matter how many devices are connected to the system, since the AV devices and speakers are connected using an external cable.

The AV system incorporating the wiring system as described above has additional merit in that it also avoids conventional difficulties in trying to arrange the cables within the room, since the arrangement of AV devices and speakers can be done by simply connecting the devices to the corresponding connector terminals provided nearby.

The AV system incorporating the wiring system as described above has further merit in that it may control the AV devices placed in several different rooms at the same time from a main room by simply and conveniently connecting one room to another through connector terminals and an external cable.

Although a few embodiments of the present invention have been shown and described, those skilled in the art will appreciate that changes may be made in these embodiments without departing from the principles and spirit of the invention, the scope of which is defined in the claims and their equivalents.

What is claimed is:

1. A wiring system connecting audiovisual (AV) devices and speakers placed in a room to enable signal transmission, comprising:
a plurality of connector terminals provided on at least one wall of the room, including top, bottom, and side walls, to which each of the speakers are connected; and
an external cable located outside the room, connecting each of said connector terminals.

2. The wiring system according to claim 1, wherein the AV devices are connected to an AV amplifier placed in the room, and said connector terminals comprise a speaker connector to which said speakers are connected and an AV sub-receiver to which said AV amplifier is connected.

3. The wiring system according to claim 2, wherein said connector terminals further comprise a speaker and video connector to provide audio as well as video signals to the AV devices and/or the speakers.

4. The wiring system according to claim 2, wherein said AV sub-receiver is connected to an AV sub-receiver placed in another room to enable signal transmissions by way of said external cable.

5. The wiring system according to claim 2, wherein said AV sub-receiver comprises audio terminals transmitting audio signals and video terminals transmitting video signals.

6. An audiovisual (AV) system, comprising:
AV devices;
speakers;
a plurality of connector terminals provided on at least one wall of a room, including top, bottom, and side walls, to which each of the AV devices and the speakers are connected; and
an external cable located outside the room, connecting each of said connector terminals.

7. The AV system according to claim 6, further comprising an AV amplifier placed in the room, wherein the AV devices are connected to said connector terminals through the AV amplifier, and said connector terminals comprise a speaker connector to which said speakers are connected and an AV sub-receiver to which said AV amplifier is connected.

8. The AV system according to claim 7, wherein said connector terminals further comprise a speaker and video connector to provide audio as well as video signals to said AV devices and/or said speakers.

9. The AV system according to claim 7, wherein said AV sub-receiver is connected to an AV sub-receiver placed in another room to enable signal transmission by way of said external cable.

10. The AV system according to claim 7, wherein said AV sub-receiver comprises audio terminals transmitting audio signals and video terminals transmitting video signals.

11. A wiring system for a home entertainment system located in a room, comprising:
speaker connectors connectable to speakers;
a sub-receiver connectable to an AV amplifier and operable to provide status information;
a speaker and video connector connectable to a display device; and
an external cable connecting the speaker connectors, the speaker and video connector, and the sub-receiver from a position outside of the room.

12. The wiring system of claim 11, further comprising:
a second sub-receiver connectable to a second home entertainment system in a second room; and
wherein the external cable transmits audio signals and video signals to the sub-receiver in the second room.

13. The wiring system of claim 11, wherein the speaker connectors are mounted on a room surface proximate to the speakers, the speaker and video connector is mounted on a room surface proximate to the display device, and the sub-receiver is mounted on a room surface proximate to the AV amplifier.

14. A home entertainment control system, comprising:
a first sub-receiver connectable to a first home entertainment system in a first room;
a second sub-receiver connectable to a second home entertainment system in a second room;
an external cable connecting the first sub-receiver and the second sub-receiver and configured to transmit audio signals and video signals; and
a controller in the first room operable to control the first home entertainment system or the second home entertainment system.
